(19) United States
(12) Patent Application Publication
(10) Pub. No.: US 2009/0319661 A1
(43) Pub. Date: Dec. 24, 2009

(54) CLUSTER NODE CONTROL APPARATUS OF FILE SERVER

(75) Inventors: Kensuke Shiozawa, Kawasaki (JP); Yoshitake Shinkai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/415,387

(22) Filed: Mar. 31, 2009

(30) Foreign Application Priority Data
Jun. 24, 2008 (JP) 2008-163983

(51) Int. Cl. G06F 15/173; G06F 15/16; H04L 9/32

(52) U.S. Cl. 709/225; 709/232; 726/5

(57) ABSTRACT

When a network file service is transferred from a transfer source node to a transfer target node, a file service state utilized by a client in the transfer source node is transferred to the transfer target node. Then, after the file service state is transferred to the transfer target node, a file service request (I/O request) reached from the client to the transfer source node is transmitted to the transfer target node.

### CROSS-REFERENCE TO RELATED APPLICATION

This application is based upon and claims the benefit of priority of the prior Japanese Patent Application No. 2008-163983, filed on Jun. 24, 2008, the entire contents of which are incorporated herein by reference.

### FIELD

The embodiment discusses herein is directed to a technology for the file service in a clustered server.

### BACKGROUND

In recent information technology fields, NAS (Network Attached Storage) is an important technical element as the file server for making data to be shared by a plurality of clients. Access protocols for NAS can be divided into two, namely, protocols for managing in detail a client/service state on a server side (stateful-protocol) and other protocols (stateless-protocol). The typical example of the former is NFS (Network File System) mainly for UNIX (registered trademark) system clients, and the typical example of the latter is CIFS (Common Internet File System) mainly for Windows (registered trademark) system clients

In NAS, the improvement of the service availability thereof is also demanded for the purpose of data centralized service. As one of technologies for improving the service availability, there is the service clustering. In this case, when a node or the service processing a service request from a client is stopped due to the system failure events or the system management operations, and the like, the service is transferred to another node, so that the service is taken over by the transfer target node.

Regarding the service of CIFS protocol, when the service is transferred to the transfer target node, since the connection to a client accessing the transfer source node is shut down, and also, a file service state in the transfer source node set up by the client is destructed, there is a possibility that an error occurs in a user application. The reasons of the service transfer include not only the occurrence of the system failure such as the cluster node fail over, but also the cluster management operation such as the service take over for the purpose of load balancing and recovering the failed cluster node. Although it is unavoidable that the error occurs due to the system failure events, it is not preferable from the viewpoint of ensuring the service quality that the error occurs due to the management operations.

### SUMMARY

According to an aspect of the embodiment, when an instruction to transfer the network file service between the nodes of a cluster system is received, a file service state utilized by a client in a transfer source node is transferred to a transfer target node. Then, after the file service state is transferred to the transfer target node, a file service request reached from the client to the transfer source node is transmitted to the transfer target node.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic configuration view of one embodiment of the file server;

FIG. 2 is an explanatory view of processing of transferring of the network file service;

FIG. 3 is an explanatory view of quiescence processing of a filer service state;

FIG. 4 is an explanatory view of substitutive processing of login authentication in a transfer source node;

FIG. 5 is an explanatory view of processing of transferring a SMB signature context; and

FIG. 6 is an explanatory view of processing of synchronization the SMB signature contexts.

### DESCRIPTION OF EMBODIMENT

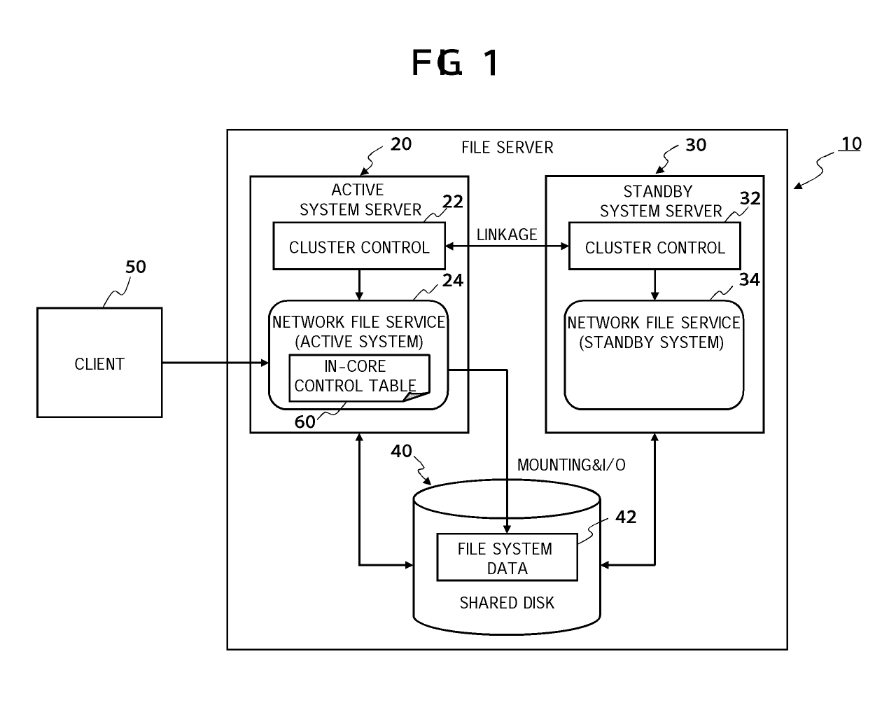

FIG. 1 illustrates a schematic configuration of one embodiment of the file server.

The filer server 10 includes; an active system server 20 and a standby system server 30 which set up a clustering system; and a shared disk 40 commonly used by the active system server 20 and the standby system server 30. The active system server 20 and the standby system server 30 is each made up by a general-purpose computer functioning as a cluster node, and cluster controls 22 and 32 each of which functions as a cluster node control program are incorporated into the active system server 20 and the standby system server 30, respectively. Further, in order to respond to a service request from a client 50 made up by a general-purpose computer, network file services 24 and 34 are incorporated into the active system server 20 and the standby system server 30, respectively. The network file services 24 and 34 can input/output file system data 42 by being mounted onto the shared disk 40 when operating as active system servers. Incidentally, the number of servers configuring the clustering system is not limited to two, and more than two servers may configure the clustering system.

The cluster control 22 incorporated into the active system server 20 monitors an operating state of the network file service 24 to judge whether or not the network file service 24 is stopped due to the system failure events or the system management operations, and the like. Then, the cluster control 22 incorporated into the active system server 20, when it is judged that the network file service 24 is stopped, cooperates with the cluster control 32 incorporated into the standby system server 30 to transfer the network file service to the standby system server 30 from the active system server 20. Accordingly, a user of the file server 10 is possible to stably get the file service without awareness of an influence due to the system failure events or the like.

In the network file service 24 of the active system server 20, an in-core control table 60 indicating a file service state to the client 50 is set up. Into the in-core control table 60, there are registered as the file service state, for example, connected communication information, authenticated account information, volume information, open file information, directory search information, file state transition monitor information, a deferred open processing context, a file-lock control context and pipe processing associated information. As the connected communication information, there can be used, for example, a negotiated communication protocol such as NT1 and LANMAN, an negotiated authentication protocol such as whether spnego or not, capability of both of client/server such as whether corresponding to EXTENDED_SECURITY or not, a SMB (Server Message Block) signature context such as a signing key and a deferred process context list, and a maximum transmission/reception size determined at an initial login time. As the connected account information, there can be used, for example, an account identifier (vuid) and authentication processing results such as NT account record information and UNIX (registered trademark) account record information. As the volume information, there can be used, for example, identifiers such as a volume identifier (tid) and a service identifier (snum), volume information such as file system path information, and TRANS system storage request data to volume. As the open file information, there can be used, for example, an open file identifier (fid), file information such as a path and a device number, open information such as request authorization and share designation, a BREAK request of OPLOCK from another session relevant service, and an OPLOCK processing state such as whether or not BREAK of OPLOCK is being issued and a time-out value of a BREAK reply. As the directory search information, there can be used, for example, an identifier (dnum), search conditions such as directory path information and a search wildcard, and a search state such as scan offset. As the file state transition monitor information, there can be used, for example, monitoring object file information being open file/volume specific information, and monitor request contents defining what state transition of the file is to be monitored, and the like. As the deferred open processing context, there can be used, for example, an original open request message, deferred duration information such as a deferred starting clock time and a time-out clock time, and opening object file information such as an inode number and a device number. As the file-lock control context, there can be used, for example, object file information such as open file specific information, lock information such as an offset, a range and a lock type, a lock request state such as discrimination of release waiting/authorization and waiting time-out information. As the pipe processing associated information, there can be used, for example, a service object identifier (pnum), service information such as a service name, pipe authentication information containing an authenticating state, and storage request data/storage reply data to a pipe.

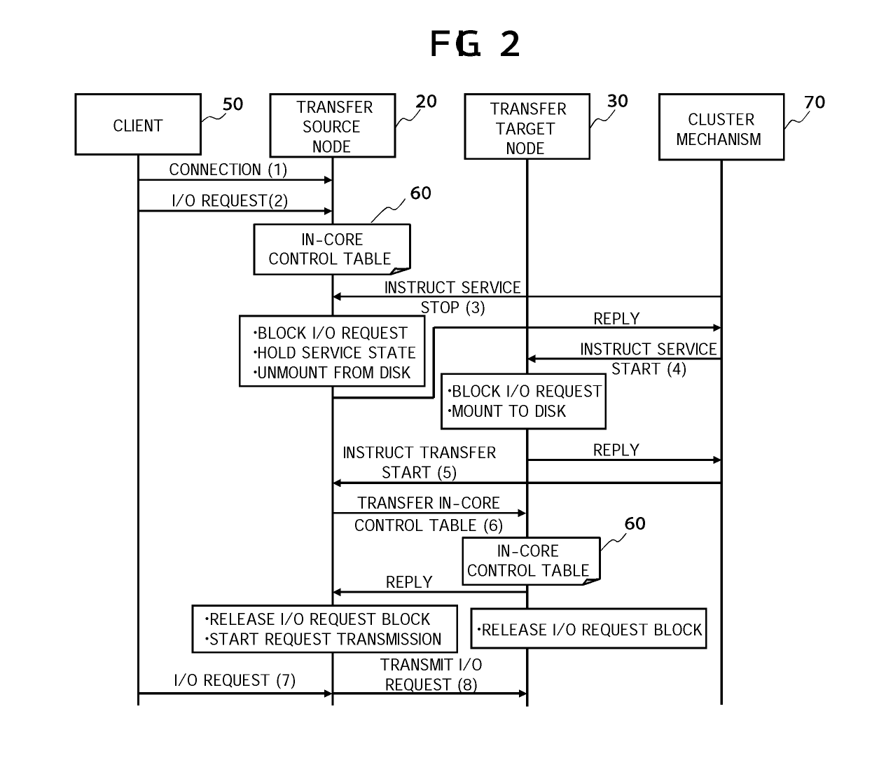

Next, in reference to FIG. 2, there will be described the details of processing of transferring the network file service to the standby system server 30 from the active system server 20 due to the management operations reasons. In the following description, the active system server 20 is referred to as “transfer source node 20” and the standby system server 30 is referred to as “transfer target node 30”. Further, the cluster controls 22 and 32 incorporated into the transfer source node 20 and the transfer target node 30, respectively, are collectively referred to as “cluster mechanism 70”.

When the client 50 is connected to the transfer source node 20 (1) and an I/O request (2) for the file service is made to the transfer source node 20, the in-core control table 60 is set up in the network file service 24. Then, when a service transferring instruction is issued by a system manager, a service stopping instruction (3) is transmitted from the cluster mechanism 70 to the transfer source node 20. In the transfer source node 20 received the service stopping instruction (3), the I/O request from the client 50 is blocked, and the file service state is stored in the in-core control table 60, and at the same time, is un-mounted from the shared disk 40. After this processing is completed, a service starting instruction (4) is transmitted from the cluster mechanism 70 to the transfer target node 30. In the transfer target node 30 received the service starting instruction (4), the I/O request from the client 50 is blocked, and at the same time, is mounted to the shared disk 40. Thereafter, a transfer starting instruction (5) is transmitted from the cluster mechanism 70 to the transfer source node 20. In the transfer source node 20 received the transfer starting instruction (5), in accordance with the instruction to transfer the in-core control table 60 to the transfer target node 30 (6), the transfer of the in-core control table 60 to the transfer target node 30 and the release of the I/O request from the client 50 blocked therein are instructed. Thereafter, the I/O request blocked in the transfer source node 20 is released, and a processing of transferring the I/O request to the transfer target node 30 is started. Then, in the transfer source node 20, when an I/O request (7) from the connected client is received at the time of starting the file service transfer, the I/O request (7) is transmitted to the transfer target node 30 without denial (8).

Thus, when the network file service is transferred from the transfer source node 20 to the transfer target node 30, the file service state set up in the network file service 24 of the transfer source node 20 is taken over to the transfer target node 30. Further, after the network file service is transferred to the transfer target node 30, the I/O request reached the transfer source node 20 from the client 50 is transmitted to the transfer target node 30. Therefore, at the time of starting the network file service transfer, the connection to the client 50 who has gotten the file service in the transfer source node 20 is not shut down, and consequently, it is possible to prevent the error occurrence in a user application.

Next, there will be described various types of options additionally applicable to the file server 10.

(1) Transfer of a Control Cache File of the File Service

In Windows (registered trademark) system clients, a file access protocol called CIFS is utilized. In a typical server (samba server) corresponding to the CIFS protocol, in addition to the in-core control table 60, a control cache called a TDB (Trivial Database) file holding some control data is provided. Most of TDB files are used for sharing data by inter-processes configuring the samba server, but among them, there is the one holding data in place of the in-core control table 60. This control cache file is not separated in file system units, and therefore, cannot be transferred by a method of mounting to the shared disk 40 from the transfer target node 30.

Therefore, only the control data associated with the transfer object file service may be extracted from the TDB file to be transferred to the transfer target node 30, similarly to the in-core control table 60. Incidentally, as data required to be extracted from the TDB file and to be transferred to the transfer target node 30, for example, the information of the OPLOCK holder and its waiter (locking.tdb), and the information of the byte range lock holder and its waiter (brlock.tdb) are assumed.

(2) Freezing of the File Service State

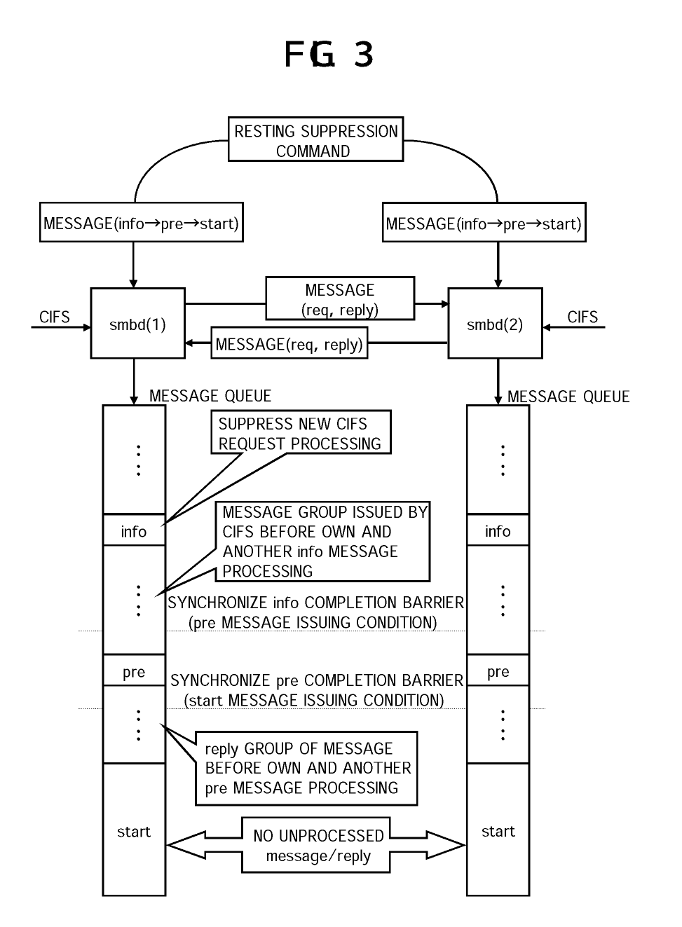

Since the file service's intermediate raw states such as the file lock being waited for its release and the OPLOCK being waited for the completion of BREAK is transferred as it is, in the transfer source node 20, it is unnecessary to perform such complicated quiescence operation as that performed in the backup of the file system. Instead, as indicated in FIG. 3, in the transfer source node 20, only the freezing of the raw intermediate states associated with the transfer object file service is required. As the freezing operation performed in the transfer source node 20, for example, processing of keeping a new file service request from the client (containing a login request and a logoff request) on hold until the service transfer completion, processing unprocessed messages among inter-process messages configuring the CIFS server and flash processing of DIRTY file cache data to the shared disk 40 are assumed. Incidentally, the new file service request which is kept on hold is transmitted to the transfer target node 30 when the file service transfer is completed.

On the other hand, in the transfer target node 30, until the transfer of the file service state is completed, the file service to a request directly reached thereto is kept on hold. This is because, for example until a lock acquired state and the like are transferred, it is not possible to accurately judge whether the lock request needs to be authorized, denied or reserved.

(3) Substitutive Login Authentication in the Transfer Source Node

When the Kerberos is utilized as an authenticating method, a service ticket provided from the client 50 together with the login request is encrypted by a KDC (Key Distribution Center) using a secret key of a destination node thereof. Therefore, even if the login authentication request is transmitted to the transfer target node 30, the service ticket cannot be decoded in the transfer target node 30.

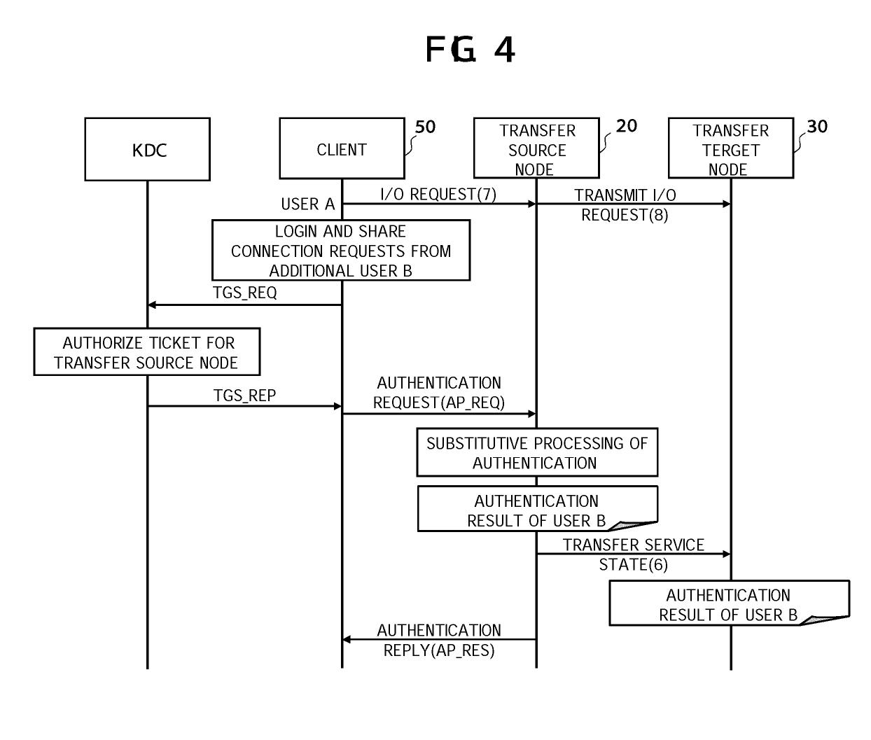

In this connection, as indicated in FIG. 4, the login request (SESSSETUP) and a communication protocol negotiation request (NEGPROT) made in advance of the login request are processed in substitutive in the transfer source node 20 regardless of whether or not the service transfer processing is completed, and the authentication result is transferred to the transfer target node 30.

In a partial pipe service such as NETLOGON and WINREG, due to client circumstances of the service, in addition to the login authentication at a session connecting time, the authentication processing may be performed even when the pipe service is bounded. In order to process the authentication of this type in substitutive in the transfer source node 20, it needs to be judged, based on the I/O request to be transferred to the transfer target node 30, whether or not the authentication processing needs to be performed. However, the storing processing of a large number of messages reached to the pipe service needs to be performed before the necessity of authentication processing can be judged, and therefore, the substitute authentication is not practical when the relation to the SMB signature processing and the like is additionally considered.

Therefore, the protocol negotiation limiting the in-pipe authentication to a NTLM (NTLAN Manager) system in which the authentication destination node is not specified is performed, to thereby solve the above problem.

A final result of the login authentication is transferred to the transfer target node 30 as described above. However, this final result is also held in the transfer source node 20 until the logoff request associated with the account is completed in the transfer source node 20 or in the transfer target node 30. This is to avoid that the account identifier in use is inappropriately used when the login request associated with the other account is performed.

Incidentally, after the service is transferred, the login request is processed in substitutive in the transfer source node 20 and the authentication result is transferred to the transfer target node 30. At this time, the freezing of the file service does not need to be performed. This is because the account requesting login does not set up the file service state in advance (there is no influence on the referring/updating of the file service state by the other account), and other activities by this account are not performed until the login authentication is completed.

(4) Connection to the Transfer Target Node by a Transfer Target Machine Account

In order to transfer the file service state and to transfer the I/O request, it is necessary to set up a communicative session from the transfer source node 20 to the transfer target node 30. However, this communicative session setting-up is not able to be realized only by transferring the login request to the transfer source node 20. In order to set up the communicative session, there is a method of permitting the login request from the transfer source node 20 without restriction, but there is a possibility that a security hole is made. Further, there is a method of preparing a dedicated account for a transfer processing in the transfer target node 30 to request the communicative session setting-up by the dedicated account. However, an authenticated password of the account is shared in distributive between the cluster nodes, and accordingly, there is a possibility that the management operations and logics are to be unnecessarily complicated. Furthermore, there is also a method of using a guest account, but since information processed by such an account is private data of the other account, such a method is too risky.

Therefore, a cluster node as a domain member node of a directory service system may be set up, and a transfer target machine account being one type of a domain account thereof may be used to make the login request in the transfer target node 30, so that the communicative session is set up between the transfer source node 20 and the transfer target node 30.

(5) Transfer of the File Service State as the LANMAN Service

In the processing of requesting the file service state transfer, it is desirable to suppress the consumption of resource (control table) required directly for the transfer processing at minimum. Further, it is desirable to suppress the existing protocol extension as minimum as possible.

Therefore, as the transfer request service, the LANMAN service (the pipe service through which a TRANS request passes) satisfying the above both conditions may be adopted.

(6) Advanced Reservation of Various Identifiers in the Transfer Processing of the File Service State

Since the transfer request of the file service state is processed by the transfer target machine account being one type of the domain account, the account identifier (vuid) thereof is also needed by one in the transfer target node 30. Further, since the above-mentioned transfer request is processed as the LANMAN service which is newly set up in a pseudo volume IPC$ for issuing a control command, one volume identifier (tid) thereof is also needed in the transfer target node 30.

The normal account identifier (vuid) and the normal volume identifier (tid) are contained in the I/O request to be transmitted from the transfer source node 20 to the transfer target node 30 and the file service state itself to be transferred from the transfer source node 20 to the transfer target node 30. When the I/O request is transmitted and the file service state is transferred, if these identifiers are the same as those for the transfer processing, there is considered a method of appropriately changing these identifiers to other identifiers. However, considering the repetition of changing processing of these identifiers, performance degradation and processing logic complication are concerned, and therefore, such a method is never preferable.

Therefore, at the time of starting a system, the account identifier (vuid) and the volume identifier (tid) may be especially reserved in advance so as to avoid that these reserved identifiers are the same as the account identifier/volume identifiers in the normal filer service request processing.

(7) Transfer of the SMB Signature Context

The SMB signature processing associated with the I/O request transferred from the transfer source node 20 to the transfer target node 30 can only be performed in the transfer target node 30. This is because, for example, when competitive locks occur due to the bite range lock request, the processing of the I/O request needs to be deferred until this competition is resolved. This is because a deferred processing context for this purpose can only be managed in the transfer target node 30 having the file serve state thereof, and context information is necessary for the SMB signature of the deferred I/O request reply.

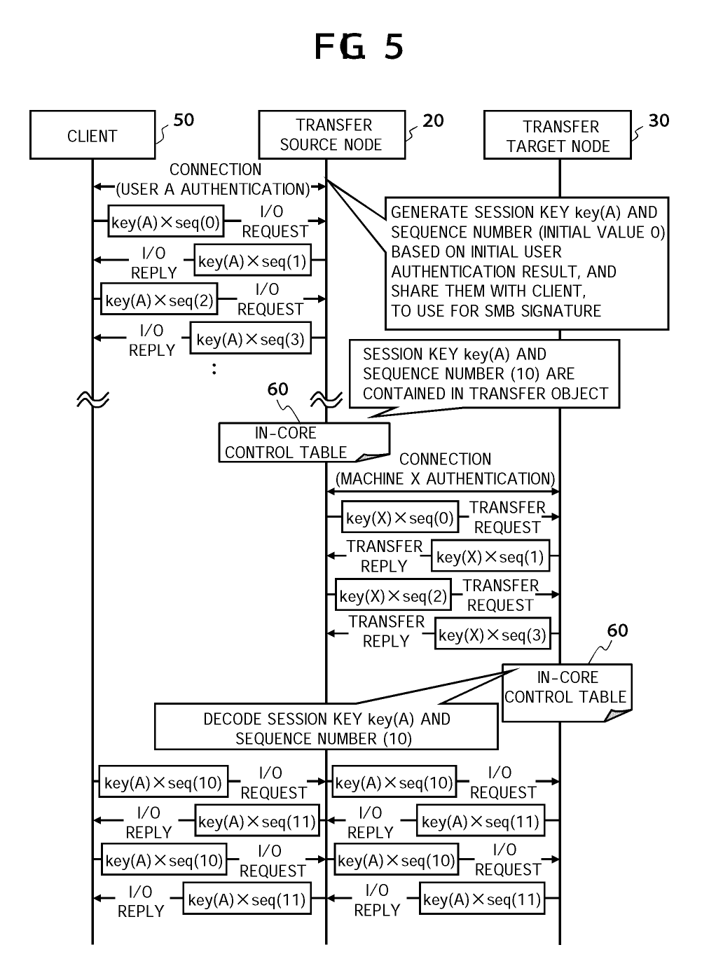

As indicated in FIG. 5, for sign processing/sign check processing of the SMB signature, a signing key (key) obtained at the authentication time of the login requester is used, but the signing key on the connected session is not able to be changed in mid-flow. Therefore, the signing key obtained in the login authentication performed in the transfer source node 20 needs to be transferred to the transfer target node 30.

The transfer request of the file service state is performed using the transfer target machine account. However, the session connection by this account determines the SMB signing key and a sequence number in the session between the transfer source node 20 and the transfer target node 30. Therefore, in the final stage of the file service state transfer processing, the SMB signing key and the sequence number are corrected in conformity with the SMB signature context set up in the transfer source node 20 by the client 50.

(8) SMB Signature Context Synchronization Between the Transfer Source Node and the Transfer Target Node

As described in the above, the login authentication to the transfer object network file service needs to be performed in the transfer source node 20. However, the SMB signature processing is also necessary for the login request and the reply, and therefore, the following problem is caused by simply transferring the SMB signature context to the transfer target node 30. Namely, since the newest SMB signature context is managed in the transfer target node 30, the login request sign check processing and the login reply sign processing may be requested to the transfer target node 30 from the transfer source node 20 at each time.

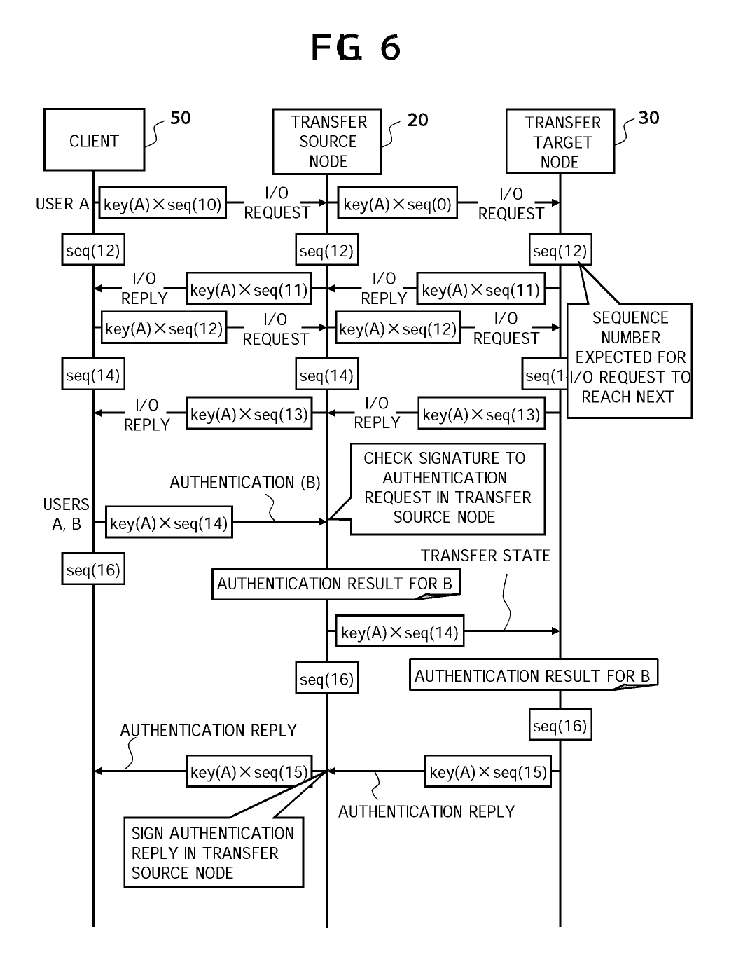

Therefore, as indicated in FIG. 6, in the transfer source node 20, the SMB signature context may be synchronized with that in the transfer target node 30 as needed, so that the SMB signature can be performed in the own node. Namely, even after the SMB signature context is transferred, the SMB signature context is held in the transfer source node 20. Then, in the transfer source node 20, at each time when the I/O request is transferred to the transfer target node 30, the SMB signature context in the own node is updated (2 is added to the sequence number), to be always synchronized with the SMB signature context in the transfer target node 30. Further, in the transfer source node 20, when the login request is detected, the request sign check and the reply sign check are performed using the newest SMB signature context always synchronized with that in the transfer target node 30. Incidentally, before the reply is transmitted to the client 50, a KEEPALIVE message is transmitted to the transfer target node 30, and the SMB authentication context in the transfer target node 30 is updated, similarly to the updating at the I/O request transfer time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer readable recording medium storing a cluster node control program of a file server causing a computer to execute a process comprising:
transferring a file service state utilized by a client in a transfer source node, to a transfer target node, when an instruction to transfer a network file service between nodes of a clustering system is received; and
transmitting a file service request reached from the client to the transfer source node, to the transfer target node, after the file service state is transferred to the transfer target node.

2. A computer readable recording medium storing a cluster node control program of a file server causing a computer to execute a process according to claim 1,
wherein the transferring the file service state to the transfer target node extracts control data associated with the file service state utilized by the client from a control cache file provided in the transfer source node, to transfer the extracted control data together with the file service state to the transfer target node.

3. A computer readable recording medium storing a cluster node control program of a file server causing a computer to execute a process according to claim 1, further comprising
freezing of raw intermediate state of the file service in the transfer source node, when the instruction to transfer the network file service is received, and also, keeping a processing to the file service request on hold until the transfer of the file service is completed in the transfer target node.

4. A computer readable recording medium storing a cluster node control program of a file server causing a computer to execute a process according to claim 1, further comprising
processing a login authentication request from the client in substitutive in the transfer source node, and transmitting the authentication result to the transfer target node.

5. A computer readable recording medium storing a cluster node control program of a file server causing a computer to execute a process according to claim 4,
wherein the authentication result to the login authentication request is held in the transfer source node until a logoff request is completed.

6. A computer readable recording medium storing a cluster control program of a file server causing a computer to execute a process according to claim 1, further comprising
providing the cluster node as a domain member node of a directory service system, and establishing a communicative session between the transfer source node and the transfer target node by performing a login request to the transfer target node using a transfer target machine account being one type of a domain account.

7. A computer readable recording medium storing a cluster node control program of a file server causing a computer to execute a process according to claim 1,
wherein the transferring the file service state to the transfer target node transfers the file service state using a LANMAN service.

8. A computer readable recording medium storing a cluster node control program of a file server causing a computer to execute a process according to claim 1,
wherein an account identifier and a volume identifier contained in the file service state are reserved in advance, further comprising
referring to the account identifier and the volume identifier which are reserved in advance, and avoiding that the preserved identifiers are the same as an account identifier and a volume identifier in processing to the file service request from the client.

9. A computer readable recording medium storing a cluster node control program of a filer server causing a computer to execute a process according to claim 1, further comprising
changing a signing key and a sequence number of a session between the transfer source node and the transfer target node in conformity with a SMB signature context set up in the transfer source node, after the file service state is transferred to the transfer target node.

10. A computer readable recording medium storing a cluster node control program of a filer server causing a computer to execute a process according to claim 1, further comprising
holding a SMB signature context in the transfer source node even after the network file service is transferred and synchronizing the SMB signature context with that in the transfer target node each time when the file service request is transmitted to the transfer target node, and also, performing a SMB signature using the SMB signature context when a login request is made to the transfer source node.

11. A cluster node control method of a filer server, which is executed in a computer, the method comprising:
transferring a file service state utilized by a client in a transfer source node, to a transfer target node, when an instruction to transfer a network file service between nodes of a clustering system is received; and
transmitting a file service request reached from the client to the transfer source node, to the transfer target node, after the file service state is transferred to the transfer target node.

12. A cluster node control apparatus of a filer server comprising:
state transfer means for transferring a file service state utilized by a client in a transfer source node, to a transfer target node, when an instruction to transfer a network file service between nodes setting up a clustering system is received; and
request transfer means for transmitting a file service request reached from the client to the transfer source node to the transfer target node, after the file service state is transferred to the transfer target node by the state transfer means.
